(19) United States
(12) Patent Application Publication
(10) Pub. No.: US 2024/0240423 A1
(43) Pub. Date: Jul. 18, 2024

(54) MULTI-TIER FRICTION LINER

(71) Applicant: Agru/America, Inc., Georgetown, SC (US)

(72) Inventors: Gunther Niedermoser, Murrells Inlet, SC (US); William Andrew Urchik, Corfu, NY (US)

(73) Assignee: Agru/America, Inc., Georgetown, SC (US)

(21) Appl. No.: 18/558,433

(22) PCT Filed: May 5, 2022
(86) PCT No.: PCT/US2022/027767

§ 371 Date: Nov. 1, 2023

Related U.S. Application Data
(60) Provisional application No. 63/184,991, filed on May 6, 2021.

(51) Int. Cl. E02D 17/20

(52) U.S. Cl. CPC E02D 17/202

(57) ABSTRACT

Described herein are multitier geomembrane products (100), and methods for making same, for usage in landfills, mineral and metal mines, etc., that may or may not be located in seismically active geographies wherein the geomembrane (100) includes enhanced surface features that combine different geometries into a final textured geomembrane product. The multitier geomembrane product includes a geomembrane material having at least one of a high density polyethylene (HOPE), a medium density polyethylene (MDPE), and a linear low density polyethylene (LLDPE); and polypropylene (PP), the geomembrane material further including an upper surface from which a plurality of friction spikes protrude.

### CROSS REFERENCE TO RELATED APPLICATION

This application claims priority to U.S. Provisional Patent Application No. 63/184,991, titled Multi-Tier Friction Liner, filed on May 6, 2021, the disclosure of which is incorporated by reference.

### TECHNICAL FIELD

The subject matter disclosed herein is generally directed to new geomembrane products, and methods for making same, for usage in landfills, mineral and metal mines, ponds, impoundments, closures, etc., that may be located in geographies wherein the geomembrane is required to offer enhanced features that offer greater surface texturing to maximize interface friction and improve stability into a final textured geomembrane product.

### BACKGROUND

In terms of mechanical properties, untreated municipal solid waste (MSW) is a composite material. The shear strength of MSW consists of two major resistance components, friction and tension (reinforcement). Frictional forces arise between all waste particles, particularly between granulars. Tensile forces on the other hand are incorporated in fibrous elements (foils, fibers), only. The shear resistance generated by tensile forces is called fiber cohesion. In many regards, the granular part of the matrix is different from the fibrous part. Among others, isotropy, stress-strain behavior and sensitivity against biological and chemical decay processes vary significantly. These different properties result in several consequences.

When constructing landfills, mineral and metal mines, ponds, impoundments, closures, etc., two of the greatest concerns are stability of the final configuration and stability of the project during construction. To achieve stability, a texturing is incorporated into the geomembrane, which improves interface friction against adjacent components in the liner configuration. Industry standards/applications vary, which has resulted in large failures in the mentioned facilities.

It is impossible to exactly determine the shear strength of a landfill liner or closure in one single laboratory test but comprehensive empirical models may be used to determine stability of facility configurations both during the construction phase and long term.

Although the majority of facilities are constructed and operated safely, several major slope failures have occurred in U.S. and international projects. U.S. failures have occurred during as well as post-construction. Internationally, widely known failures have been at uncontrolled facilities and led to significant loss of life. The most notable accidents were in Turkey and the Philippines. The largest U.S. facility slope failures occurred in Ohio and other states. Smaller incidents have been associated with seismic activity in some states.

It is important to understand static and seismic slope stability, and how it is used to determine stability. For example, if a liner is damaged, the waste above that area must be removed and a new liner must be installed. A cover failure requires reinstallation. When a large quantity of waste becomes unstable, it must be moved over the lined area and re-covered. These remedial actions are expensive.

Liner system construction is important to slope stability. An earthen berm can be constructed at the base of a landfill slope to provide resistance to lateral slope movement in an adjacent cell or undeveloped area. Some slope failures have occurred when the berm was removed during new cell construction and when the berm was not large enough to provide sufficient resistance to lateral slope movement.

A liner system generally consists of one or more soil and/or geosynthetic materials such as geomembranes, geosynthetic clay liners, geocomposites, geonets, geogrids, geotextiles and other geosynthetic products. Between or above these liners are layers of drainage media comprised of soil or geosynthetic materials. These materials' shear strength and the interface shear strength between the layers determine how susceptible the system is to lateral movement along geosynthetic interfaces in response to forces generated by the waste's mass or other forces generated like seismic forces.

Sliding along a geosynthetic interface can harm the liner system's containment function. If sliding occurs below the geomembrane at a compacted clay liner/geomembrane interface, the geomembrane will stretch and possibly tear. This has occurred in static slope stability failures and in at least one seismic event.

If the geomembrane tears, or punctures from movement due to insufficient shear strength, a leak in the liner system could occur. This tear or puncture may not be detectable from the surface if the slope experiences a large lateral movement. This occurred at a Midwest facility in which the damaged geomembrane would not have been uncovered and remediated if the slope toe had not been excavated to connect the geosynthetics of the adjacent cell to the geosynthetics in the existing cell.

Another potential interface failure occurs when one geosynthetic layer of the liner system slides over another geosynthetic layer. Forces on a geosynthetic layer placed over a geomembrane liner may cause the geosynthetic to slide along the geomembrane. The sliding potential can be evaluated by measuring the interface shear strength between the geomembrane and adjacent geosynthetic using standard direct shear testing. Each geosynthetic component can slide, depending on the forces applied to it. This can result in tears, punctures and unwanted wrinkles t the geosynthetic. A soil/geosynthetic or a geosynthetic/geosynthetic interface can slide if the interface shear strength is less than the shear force induced by the materials above the interface.

For many years, there have been embossed textured geomembrane products on the market for landfill, mining, coal ash impoundment and other geomembrane lining and capping applications. These products are made on a flat die extrusion line with calendaring rollers that have geometries machined, carved out, blasted, etc., or by displacing material in the surface of the roller(s). The friction pattern is a repeating pattern based on the geometry selected.

Surface texturing is used to improve interfacial shear strength, which is required when lining a project. This is extremely critical when the application is located in a seismic sensitive area, which are commonly found across the U.S. In these areas, as well as in areas where seismic activity is not of concern, another element called large displacement shear strength is needed. This is the measurement of the shear stress in accordance to ASTM D5321 after the interface has been mobilized and is typically measured after 2″ or 3″ of displacement. This is required under low normal loads as well as high normal loads of 30,000 psf and sometimes as high as 50,000 psf depending on the project type.

What is needed is an improved membrane that improves shear strength as compared to previously available membranes. Accordingly, it is an object of the present disclosure to combine different geometries into one geomembrane textured product.

Citation or identification of any document in this application is not an admission that such a document is available as prior art to the present disclosure.

### SUMMARY

The above objectives are accomplished according to the present disclosure by providing a geomembrane product that improves shear strength as shown and disclosed herein.

In a further embodiment, methods are provided for making a geomembrane that improves interface shear strength as shown and disclosed herein.

In a still further embodiment, the present disclosure provides for methods of installing a geomembrane that improves shear strength as shown and disclosed herein.

In accordance with one aspect of the present disclosure, a multitier geomembrane product for improving interfacial direct shear resistance is provided. The geomembrane product includes a geomembrane material having at least one of a high density polyethylene (HDPE), a medium density polyethylene (MDPE), and a linear low density polyethylene (LLDPE); and polypropylene (PP), the geomembrane material further including an upper surface from which a plurality of friction spikes protrude.

In accordance with one embodiment of this aspect, at least a portion of the plurality of friction spikes vary in height. In another embodiment, the plurality of friction spikes have a base diameter to height ratio of between 1 and 2. In another embodiment, the plurality of friction spikes have a base diameter to height ratio of between 1.5 and 2. In another embodiment, the base diameter to height ratio of at least one of the plurality of friction spikes is 1.667. In another embodiment, at least one of the plurality of friction spikes has a base diameter of 5 mm and a height of 3 mm. In another embodiment, at least one of the plurality of friction spikes is a large friction spike having a height range of between 1.5 mm and 10 mm.

In another embodiment, each large friction spike protruding from the upper surface is not in line with and offset from an adjacent large friction spike by an offset angle to further improve shearing resistance. In another embodiment, the offset angle is between 10 and 18 degrees. In another embodiment, the height range of the large friction spike is between 2 mm and 5 mm. In another embodiment, at least one of the plurality of friction spikes is a micro friction spike having a height range of between 0.1 mm and 1.5 mm. In another embodiment, the height range of the micro friction spike is between 0.2 mm and 1.5 mm. In another embodiment, at least one of the plurality of friction spikes is a nano friction spike having a height range of between 0.01 mm and 0.2 mm. In another embodiment, the nano friction spike has a height range of between 0.01 mm and 0.15 mm. In another embodiment, the plurality of friction spikes comprises at least a combination of large friction spikes, micro friction spikes, and nano friction spikes. In another embodiment, the plurality of friction spikes have a width to height ratio of between 1:1 and 2:1.

In accordance with another aspect of the present disclosure, a method for making a multitier geomembrane product that improves interfacial direct shear resistance is provided. The method includes providing a geomembrane material having at least one of a high density polyethylene (HDPE), a medium density polyethylene (MDPE), and a linear low density polyethylene (LLDPE); and polypropylene (PP), the geomembrane material further including an upper surface from which a plurality of friction spikes protrude. In accordance with one embodiment of this aspect, at least a portion of the plurality of friction spikes vary in height.

In accordance with yet another aspect of the present disclosure, a method of installing a multitier geomembrane product that improves interfacial direct shear resistance as shown is provided. The method includes providing a geomembrane material having at least one of a high density polyethylene (HDPE), a medium density polyethylene (MDPE), and a linear low density polyethylene (LLDPE); and polypropylene (PP). The geomembrane material further includes an upper surface from which a plurality of friction spikes protrude. In accordance with one embodiment of this aspect, at least a portion of the plurality of friction spikes vary in height.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a textured, multidimensional geomembrane;

FIG. 2 shows a photo of a geomembrane formed pursuant to the current disclosure employing an offset angle;

FIG. 3 shows interface direct shear testing data of a geomembrane of the current disclosure;

FIG. 4 shows a comparison of shear displacement curves of a geomembrane of the current disclosure; and

FIG. 5 shows one embodiment of a surface texture showing relative geometries and placements of spikes on one embodiment of a membrane of the current disclosure.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “polymer” refers to molecules made up of monomers repeat units linked together. “Polymers” are understood to include, but are not limited to, homopolymers, copolymers, such as for example, block, graft, random and alternating copolymers, terpolymers, etc. and blends and modifications thereof. “A polymer” can be can be a three-dimensional network (e.g. the repeat units are linked together left and right, front and back, up and down), a two-dimensional network (e.g. the repeat units are linked together left, right, up, and down in a sheet form), or a one-dimensional network (e.g. the repeat units are linked left and right to form a chain). “Polymers” can be composed, natural monomers or synthetic monomers and combinations thereof. The polymers can be biologic (e.g. the monomers are biologically important (e.g. an amino acid), natural, or synthetic.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

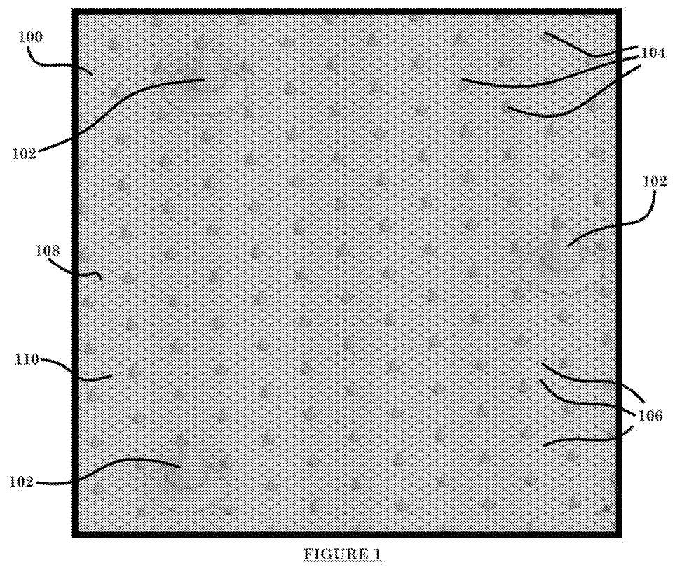

Referring to FIG. 1, the current disclosure provides a new product that combines different geometries into a textured geomembrane product 100. The material for the geomembrane could be High Density Polyethylene, (HDPE), Medium Density Polyethylene (MDPE) or Linear Low Density Polyethylene (LLDPE) and Polypropylene (PP). These materials are referred to as polyolefins.

Width and circumference are considered as these dimensions resist against bending when shearing takes place. In one embodiment, a spike of the current disclosure is 5 mm in diameter at its base and 3 mm high. Regardless of the dimensions, the current disclosure may provide a diameter to height ratio of about 1 to 2, such as 1.5 to 2.0, or more specifically a ratio of 1.667 for the spikes. If the ratio is higher than 2 then cost would be an issue as weight per square foot would be high.

For purposes of example and not intended to be limiting, this may include combining a multitude of large friction spikes 102, which may range in size from 1.5 to 10 mm, including sub-ranges within this range such as 1 to 9 mm, 2 to 9 mm, 3 to 8 mm, 4 to 7 mm, etc., with a preferred range being 2 to 5 mm. Large friction spikes 102 may be used in conjunction with a multitude of micro spikes 104, with a height range of 0.1 to 1.5 mm, including sub-ranges within this range such as 0.1 to 1.9 mm, 0.2 to 1.9 mm, 0.3 to 1.8 mm, 0.44 to 1.7 mm, etc., with a preferred range being 0.2 to 1.5 mm. Both large friction spikes 102 and micro spikes 104 may be used with a nano surface roughening process that forms nano spikes 106, which may range in size from 0.01 to 0.2 mm, such as 0.01 to 0.19, 0.01 to 0.19, etc., with a preferred range being from 0.01 to 0.15 mm. The new idea of combining multi types of spike heights improves the large displacement residual peak for the interface direct shear testing as required in seismic sensitive areas. While three different sized spikes and size ranges are herein described, the current disclosure is not so limited and more or less sizes are contemplated and disclosed herein such as 2, 4, 5, 6, 7, or more different sized/ranged spikes. The various sized spikes are formed in an upper surface 108 of membrane 110.

For the current disclosure, increase in shear strength is gained from the bending resistance of the spike and its substantial width at its base, which resists bending when sheared. The inventor's FRICTIONSPIKE™ spikes penetrate the adjacent material at its interface and the stiffness of the spikes and its bending resistance results in a higher peak shear strength. This also leads to a greater large displacement shear strength.

During shear testing, it has been observed that some geosynthetic layer will float of top of a uniform spiked geomembrane. When shear testing is performed at high pressures, the texturing of the geomembrane will bend to become virtually flat at the end of the shear test. Initially, the large spikes carry the shear load and, as displacement increases, the shear load is transferred to the smaller spikes. The large spikes utilize their stiffness and bending resistance to carry the shear load and significantly increase the peak shear strength. This will lead to an increase in large displacement shear strength as the load is transferred to the smaller spikes as displacement increases.

The width to height ratio of the spikes can be 1:1 up to 2:1. In one preferred embodiment, the ratio determined was to be 1.7:1 width to height ratio.

### Results

The interface direct shear strength of the new multi-tier friction geomembrane was found to be 20% higher than the traditional embossed textured geomembrane. The multi-tier texture system allows for better resistance to relative movement by acting at different elevations of the substrate. This creates multi layers of slip planes that allow the plowing effect by the friction spikes to occur in areas of undisturbed substrate.

The offset height and placement of the spikes results in a peak and valley affect allowing multiple levels of contact between the geomembrane and opposing geosynthetic product. This increases the resistance to relative motion between the two substrates. Also, the large spikes are not in-line which does not allow the spikes to simply follow in the pathway of an adjacent spike. This eliminates the “combing” effect against the adjacent material.

The increase in shear strength is gained from the bending resistance of the spike and its substantial width at its base, which resists bending when sheared. The FRICTIONSPIKE™ spikes penetrate the adjacent interface and the stiffness of the spikes and its bending resistance results in a higher peak and larger displacement shear strength.

During shear testing it has been observed that some geosynthetic layer will float of top of a uniform spiked geomembrane. When shear testing is performed at high pressures, the texturing of the geomembrane will bend and become flat at the end of the shear test. Initially, the large spikes carry the shear load and as displacement increases the shear load is transferred to the smaller spikes. The large spikes utilize their stiffness and bending resistance to carry the shear load and significantly increase the peak shear and large displacement strength. The increase in large displacement shear strength is significant and is used in stability analyses calculations which result in a greater factor of safety.

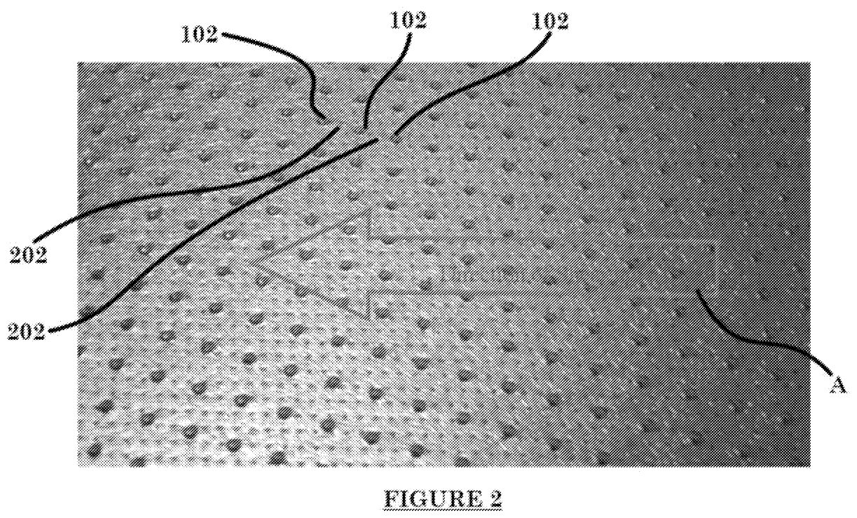

The multi-tier texture system allows for better resistance to relative movement by acting at different elevations of the substrate. This creates multi-layers of slip planes that allow the plowing effect by the friction spikes to occur in areas of undisturbed substrate. This is also magnified by the offset angle we are applying to the layout of the large spikes as seen in the photo shown at FIG. 2. As FIG. 2 shows, large friction spikes 102 are physically offset from one another on the geomembrane upper surface 108 by offset angle 202 to further improve resistance to the direction of shearing shown by arrow A.

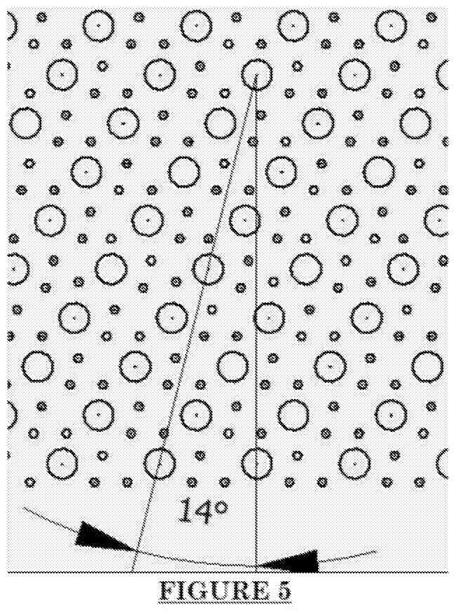

The offset of the spikes is required so one spike does not simply follow in the pathway of an adjacent spike. It is required to allow all spikes to be engaged in the adjacent material, which is being sheared. This offset allows each spike to mobilize its stiffness and bending resistance to maximize shear strength. The following or trailing spike does not repeat the same position until the 8th row of spike, as shown in FIG. 5, which provides around a 14 degree offset angle. The angle can vary from 10 to 18 degrees.

Shearing does not occur in the field unless there is a failure. Shear testing is utilized to understand the shear strength properties of two adjacent materials when placed in the field. Typically, a geomembrane is pulled down the slope from the top to the bottom. However, if access does not allow it may be pulled from the bottom up. Failure can occur in the field at various stages of construction and active use. Seismic events can increase the probability of failure and a greater large displacement shear strength will significantly decrease chances of this by increasing the factor of safety.

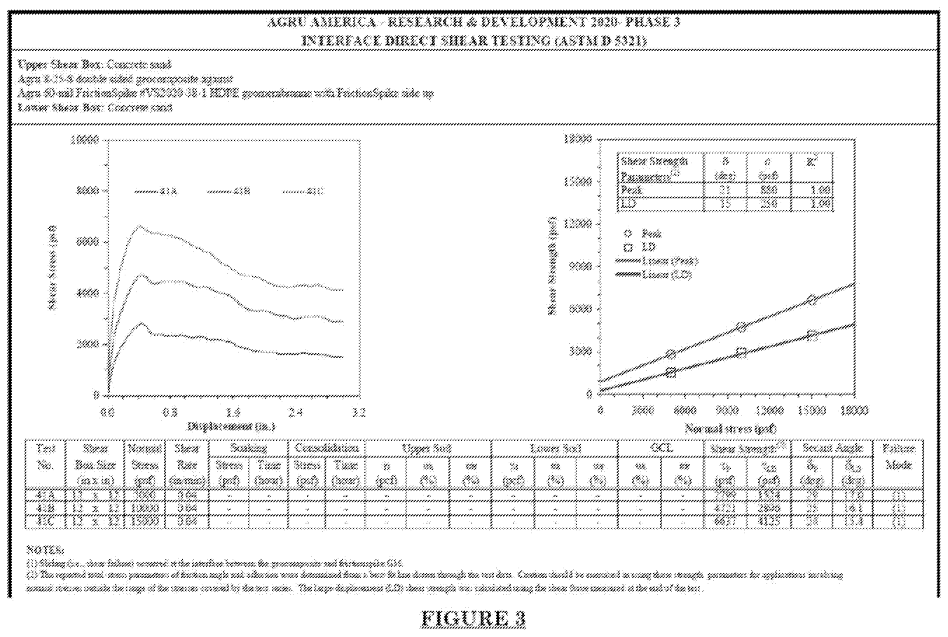

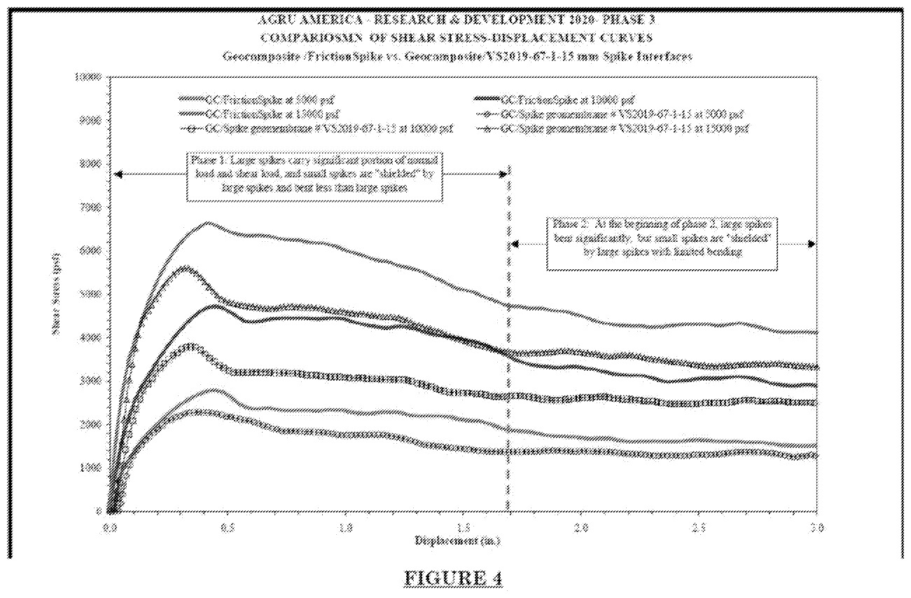

FIGS. 3 and 4 shows Interface Direct Shear Testing and Comparisons of Shear-Stress Displacement Curves of geomembranes of the current disclosure. The results are given in Shear Strength in pounds per square foot when placed in shear at a constant displacement rate according to ASTM 5321. The Peak Shear Strength is defined as the maximum value of the shear stress/displacement curve. The large displacement shear strength is obtained after displacement of two inches has occurred and is typically measured at a displacement of 3 inches.

Manufacturing of the FRICTIONSPIKE™ spikes may be performed by engraving or machining a roller with the opposite pattern as the product. Then using the roller(s) in a flat cast die extrusion process to create the desired FRICTIONSPIKE™ geomembrane.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A multitier geomembrane product for improving interfacial direct shear resistance, the geomembrane product comprising:
a geomembrane material comprising:
at least one of a high density polyethylene (HDPE), a medium density polyethylene (MDPE), and a linear low density polyethylene (LLDPE); and
polypropylene (PP),
the geomembrane material further comprising an upper surface from which a plurality of friction spikes protrude.

2. The multitier geomembrane product of claim 1, wherein at least a portion of the plurality of friction spikes vary in height.

3. The multitier geomembrane product of claim 1, wherein the plurality of friction spikes have a base diameter to height ratio of between 1 and 2.

4. The multitier geomembrane product of claim 1, wherein the plurality of friction spikes have a base diameter to height ratio of between 1.5 and 2.

5. The multitier geomembrane product of claim 4, wherein the base diameter to height ratio of at least one of the plurality of friction spikes is 1.667.

6. The multitier geomembrane product of claim 5, wherein at least one of the plurality of friction spikes has a base diameter of 5 mm and a height of 3 mm.

7. The multitier geomembrane product of claim 1, wherein at least one of the plurality of friction spikes is a large friction spike having a height range of between 1.5 mm and 10 mm.

8. The multitier geomembrane product of claim 7, wherein each large friction spike protruding from the upper surface is not in line with and offset from an adjacent large friction spike by an offset angle to further improve shearing resistance.

9. The multitier geomembrane product of claim 8, wherein the offset angle is between 10 and 18 degrees.

10. The multitier geomembrane product of claim 7, wherein the height range of the large friction spike is between 2 mm and 5 mm.

11. The multitier geomembrane product of claim 7, wherein at least one of the plurality of friction spikes is a micro friction spike having a height range of between 0.1 mm and 1.5 mm.

12. The multitier geomembrane product of claim 11, wherein the height range of the micro friction spike is between 0.2 mm and 1.5 mm.

13. The multitier geomembrane product of claim 11, wherein at least one of the plurality of friction spikes is a nano friction spike having a height range of between 0.01 mm and 0.2 mm.

14. The multitier geomembrane product of claim 13, wherein the nano friction spike has a height range of between 0.01 mm and 0.15 mm.

15. The multitier geomembrane product of claim 1, wherein the plurality of friction spikes comprises at least a combination of large friction spikes, micro friction spikes, and nano friction spikes.

16. The multitier geomembrane product of claim 1, wherein the plurality of friction spikes have a width to height ratio of between 1:1 and 2:1.

17. A method for making a multitier geomembrane product that improves interfacial direct shear resistance, the method comprising:
providing a geomembrane material comprising:
at least one of a high density polyethylene (HDPE), a medium density polyethylene (MDPE), and a linear low density polyethylene (LLDPE); and
polypropylene (PP),
the geomembrane material further comprising an upper surface from which a plurality of friction spikes protrude.

18. The method of claim 17, wherein at least a portion of the plurality of friction spikes vary in height.

19. A method of installing a multitier geomembrane product that improves interfacial direct shear resistance as shown, the method comprising:
providing a geomembrane material comprising:
at least one of a high density polyethylene (HDPE), a medium density polyethylene (MDPE), and a linear low density polyethylene (LLDPE); and
polypropylene (PP),
the geomembrane material further comprising an upper surface from which a plurality of friction spikes protrude.

20. The method of claim 19, wherein at least a portion of the plurality of friction spikes vary in height.
